(19) United States
(12) Patent Application Publication
(10) Pub. No.: US 2026/0320035 A1
(43) Pub. Date: Oct. 15, 2026

(54) IRREGULAR AND USER-DEFINED TEMPORAL QUESTION PROCESSING FOR A NATURAL LANGUAGE INTERFACE TO A DATABASE

(71) Applicant: INTERNATIONAL BUSINESS MACHINES CORPORATION, ARMONK, NY (US)

(72) Inventors: Ngoc Phuoc An Vo, Bronx, NY (US); Elahe Khorasani, YORKTOWN HEIGHTS, NY (US); Hangu Yeo, Westchester, NY (US); Vadim Sheinin, Yorktown Heights, NY (US)

(21) Appl. No.: 19/055,875

(22) Filed: Feb. 18, 2025

(51) Int. Cl. G06F 16/242; G06F 40/30

(52) U.S. Cl. CPC G06F 16/243; G06F 40/30

(57) ABSTRACT

An approach is provided for processing temporal questions for a natural language interface to a database (NLIDB). A temporal expression is detected in a received natural language question and a type of the temporal expression is identified. The type is an irregular, user-defined, or special (non-obvious or obvious) temporal expression. The temporal expression is resolved and an output of the resolution of the temporal expression is matched with temporal data stored in a database by (i) executing, for an irregular temporal expression, a series of processing logic by a natural language processing (NLP) pipeline, (ii) extracting, for a user-defined temporal expression, information by using a first pre-processed database schema view and processing a logic by the NLP pipeline, or (iii) extracting, for a special temporal expression, other information by using a second pre-processed database schema view associated with a specified use case.

### BACKGROUND

The present invention relates to a natural language interface to a database (NLIDB) system, and more particularly to resolving and processing specified temporal questions in a NLIDB system.

### SUMMARY

In one embodiment, the present invention provides a computer-implemented method. The method includes receiving a question in a natural language. The method further includes detecting a temporal expression in the question. The method further includes identifying a type of the detected temporal expression. The type is an irregular, a user-defined, or a special temporal expression. The special temporal expression is a non-obvious or an obvious temporal expression. The method further comprises resolving the temporal expression and matching an output of a resolution of the temporal expression with temporal data stored in a database by (i) executing, for the irregular temporal expression, a series of processing logic by a natural language processing (NLP) pipeline, (ii) extracting, for the user-defined temporal expression, information from the database by using a first pre-processed database schema view and processing a logic by the NLP pipeline, and (iii) extracting, for the special temporal expression, other information from the database by using a second pre-processed database schema view associated with a specified use case.

A computer system and a computer program product corresponding to the above-summarized computer-implemented method are also described herein.

### BRIEF DESCRIPTION OF THE DRAWINGS

FIG. 1 is a block diagram of a system for processing a question for a NLIDB system, where the question includes a temporal expression, in accordance with embodiments of the present invention.

FIG. 2 is a block diagram of modules included in code included in the system of FIG. 1, in accordance with embodiments of the present invention.

FIG. 3 is a block diagram of a system for processing a natural language question that includes a temporal expression within a system that converts natural language questions to a structured query language for querying structured language databases, in accordance with embodiments of the present invention.

FIG. 4 is a process for resolving and processing a temporal question for a NLIDB system, where the process is implemented in the system of FIG. 3 and operations of the process are performed by modules in FIG. 2, in accordance with embodiments of the present invention.

### DETAILED DESCRIPTION

### Overview

Conventional approaches to processing natural language queries of a database include using a NLIDB system to translate a given query from a user into a structured language with which the database can directly interact, generate a result for the query based on the structured language version of the query, and send the result to the user. Most databases store data that has a time dimension (e.g., a transaction time or a validity time) which is used in the processing of a natural language query that includes a temporal expression. To process a natural language query that has an explicit or implicit temporal expression, the NLIDB system performs (i) temporal expression resolution and (ii) matching or connecting output of the temporal expression resolution with temporal data stored in the database, which is important because each use case (e.g., Billing and Invoicing or Source to Pay use case) has a different database structure and format to store temporal data. For natural language queries having certain types of temporal expressions (i.e., types other than explicit and implicit temporal expressions), conventional approaches to processing natural language queries do not successfully decipher the certain types of temporal expressions, which leads to query results that are inaccurate, inconsistent, and/or invalid.

Embodiments of the present invention address the aforementioned unique challenges by providing an enhanced NLIDB system that (i) supports natural language questions having various types of temporal expressions and (ii) provides different levels of customization on a natural language processing (NLP) pipeline and database schemas to support questions having irregular, user-defined, and non-obvious or obvious temporal expressions. In one or more embodiments, the aforementioned customization includes (i) extra processing logic defined by a user's in-domain knowledge to resolve irregular temporal expressions and/or (ii) extra processing to connect specific user-defined or non-obvious/obvious temporal expressions with specific pre-processed database schemas for particular use cases.

In one or more embodiments, the enhanced NLIDB system disclosed herein provides two approaches to resolve irregular temporal questions and user-defined temporal questions: In a first approach, the system disclosed herein provides language-based resolution mapping specific business logic to the detected temporal expressions (e.g., YTY (year-to-year) and YTD (year-to-day), as described below). In a second approach, the system disclosed herein provides database-based manipulation to enable the processing of temporal expressions (since the original prior to the manipulation does not have this capability) (e.g., Billing and Invoicing and Source to Pay use cases, as described below).

In one embodiment, an enhanced NLIDB system disclosed herein uses a dictionary to detect irregular temporal expressions (i.e., by matching the irregular temporal expressions with entries in the dictionary) and executes a series of logic processing to resolve the detected irregular temporal expressions.

In one embodiment, an enhanced NLIDB system disclosed herein detects (i) a user-defined or a non-obvious/obvious temporal expression in a natural language question received by the enhanced NLIDB system and (ii) a particular use case specified by a context of the question, where the use case is associated with a special pre-processed database schema. Subsequently, a native SQL query generator generates a native SQL query based in part on information extracted from the database by using a view provided by the special pre-processed database schema (e.g., a view resulting from pre-processing the database schema by using SQL functions or creating new views). As used herein, a “view” (or a “database schema view”) provided by a special pre-processed database schema is also referred to as a “pre-processed database schema view.”

### Computing Environment

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, computer-readable storage media (also called “mediums”) collectively included in a set of one, or more, storage devices, and that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

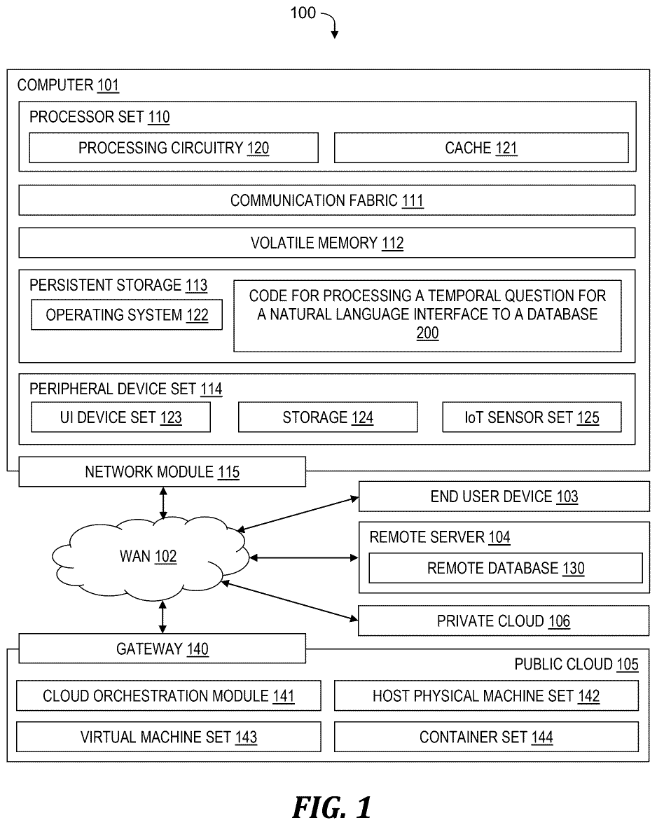

FIG. 1 is a block diagram of a system for processing a question for a NLIDB system, where the question includes a temporal expression, in accordance with embodiments of the present invention. Computing environment 100 contains an example of an environment for the execution of at least some of the computer code involved in performing the inventive methods, such as code 200 for processing a temporal question for a NLIDB system. The aforementioned computer code is also referred to herein as computer-readable code, computer-readable program code, and machine readable code. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Cloud computing services and/or microservices (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to an “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

### System and Process for Processing Temporal Questions in NLIDB

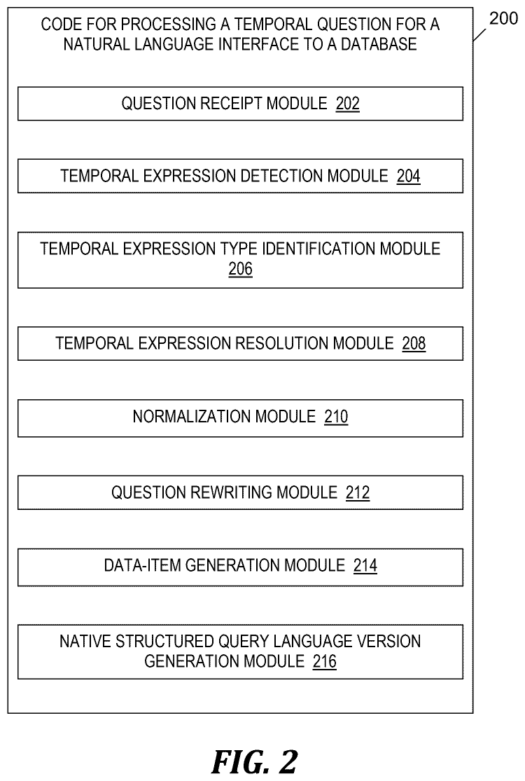

FIG. 2 is a block diagram of modules included in code included in the system of FIG. 1, in accordance with embodiments of the present invention. Code 200 includes a question receipt module 202, a temporal expression detection module 204, a temporal expression type identification module 206, a temporal expression resolution module 208, a normalization module 210, a question rewriting module 212, a data-item generation module 214, and a native structured query language version generation module 216.

Question receipt module 202 is configured to receive a question in a natural language.

Temporal expression detection module 204 is configured to detect a temporal expression included in the question received by question receipt module 202. The received question is also referred to herein as a temporal question because the question includes one or more temporal expressions.

Temporal expression type identification module 206 is configured to identify a type of the temporal expression detected by temporal expression detection module 204. In one embodiment, the identified type is (i) an explicit temporal expression, (ii) an implicit temporal expression, (iii) an irregular temporal expression, (iv) a user-defined temporal expression, or (v) a non-obvious or obvious temporal expression.

An explicit temporal expression is an expression that directly and precisely describes a specific time, such as a definite and exact date or a definite and exact date and time. For example, a temporal question that includes an explicit temporal expression is: How many products were sold in Retailer ABC on Nov. 26, 2021? In one embodiment, an NLIDB system can find an explicit temporal expression directly on a calendar.

An implicit temporal expression is an expression that implies a specific time. For example, a temporal question that includes an implicit temporal expression is: How many products were sold in Retailer ABC last Black Friday? In one embodiment, an NLIDB system transforms an implicit temporal expression into an explicit temporal expression based on a referential time.

An irregular temporal expression is a time-related expression that requires extra logic processing by an NLP pipeline to be resolved. Examples of irregular temporal expressions include: year-to-year (YTY), year-to-day (YTD), and a specified quarter of a year (e.g., Q1 to indicate a first quarter).

A user-defined temporal expression is a time-related expression whose interpretation is defined by a user and that requires extra logic processing and an extraction of information from the database by using a pre-processed database schema view. The pre-processing of the database schema is performed prior to the receipt of the question by question receipt module 202 and includes, for example, using SQL functions or creating new views. Examples of user-defined temporal expressions include (i) last weekend (which a user can specify to mean, for example, only Saturday or both Saturday and Sunday) and (ii) last week (which a user can specify to mean only the last weekdays or the last weekdays and the last weekend). An example of a temporal question that includes a user-defined temporal expression is: What has not been sold yet? (where a user can specify “yet” to mean as of today).

A non-obvious or obvious temporal expression is a time-related expression that is identified in response to an identification of a specified use case (e.g., based on the content of the question or the context of the question), where the specified use case has an associated special database schema. The special database schema is pre-processed (e.g., using SQL functions, creating new views, etc.) so that information needed to generate the native SQL query can be extracted from the database (e.g., by using a new view created by the pre-processing). The pre-processing of the special database schema is performed prior to the receipt of the question by question receipt module 202. Examples of non-obvious/obvious temporal expressions include: (i) total revenue per year/month/quarter and (ii) what is total savings of 1 H 2022/until today.

Temporal expression resolution module 208 is configured to resolve an irregular temporal expression by executing a series of extra processing logic by a NLP pipeline to process the logic of the irregular temporal expression (e.g., YTY, YTD) by retrieving different pieces of data and calculating desired information. In one embodiment, the extra processing logic is defined by a user's in-domain knowledge.

Temporal expression resolution module 208 is further configured to check for a specified use case associated with a special pre-processed database schema and to resolve a user-defined temporal expression or a non-obvious or obvious temporal expression by (i) extracting information from the database by using a pre-processed database schema view derived from the pre-processed database schema and (ii) executing extra processing logic of the temporal expression by the NLP pipeline to retrieve different pieces of data and calculate desired information needed to subsequently generate the native SQL query.

Normalization module 210 is configured to process a temporal expression into a normalized structured date and time.

Question rewriting module 212 is configured to rewrite the question so that the temporal expression is replaced with normalized values.

Data-item generation module 214 is configured to perform syntactic and semantic parsing and rule matching to generate a data-item having temporal filters.

Native structured query language version generation module 216 is configured to generate a native SQL query.

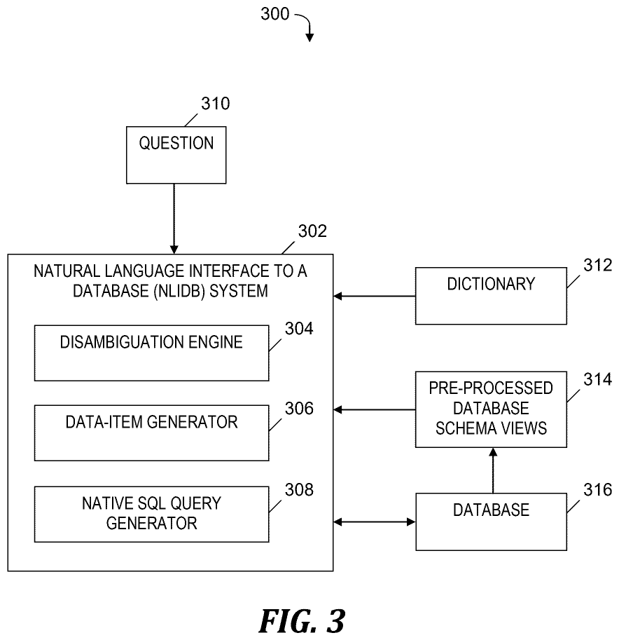

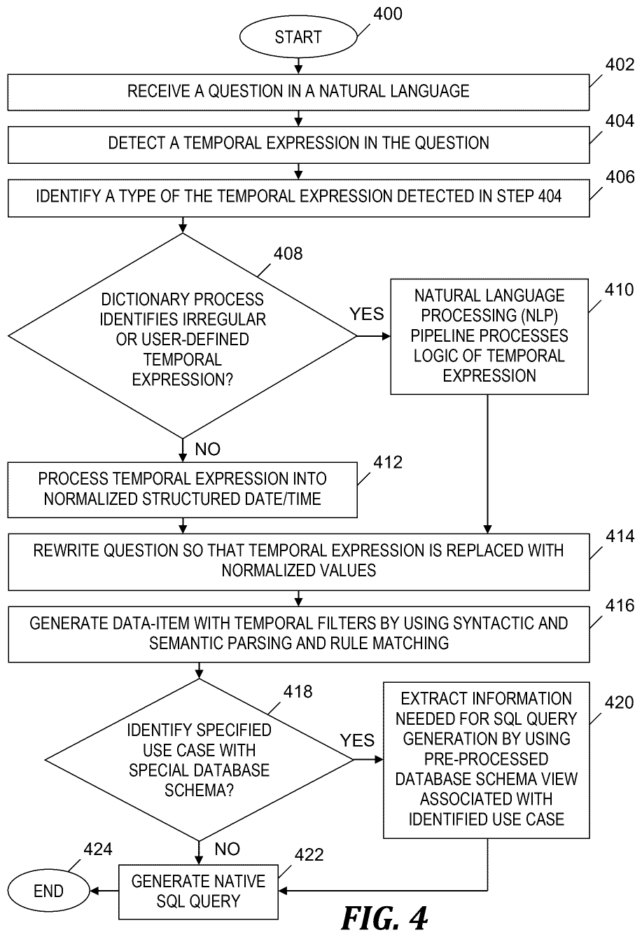

The functionality of the modules included in code 200 is described in more detail in the discussions presented below relative to FIG. 3 and FIG. 4.

FIG. 3 is a block diagram of a system for processing a natural language question that includes a temporal expression within a system that converts natural language questions to a query in a structured query language for querying structured language databases, in accordance with embodiments of the present invention. System 300 includes a software-based NLIDB system 302, which includes a disambiguation engine 304, a data-item generator 306, and a native SQL query generator 308.

NLIDB system 302 receives, resolves, and processes a question 310 (i.e., a natural language question) that includes a temporal expression. Question 310 is received from a device utilized by a user. In one embodiment, NLIDB system 302 includes a rule-based schema-independent system that converts natural language questions to SQL, which enables a user to use natural language for querying structured language databases.

Disambiguation engine 304 disambiguates question 310 by (i) detecting and identifying the type of the temporal expression included in question 310; (ii) processing the temporal expression into a normalized value (i.e., a structured date or date and time); and (iii) rewriting question 310 to replace the temporal expression with the normalized value. In one embodiment, disambiguation engine 304 detects an irregular temporal expression or a user-defined temporal expression by matching the temporal expression in question 310 to an entry in a dictionary 312. In one embodiment, disambiguation engine 304 checks whether question 310 is associated with a specified use case, which is associated with a special database schema. If the specified use case is identified, disambiguation engine 304 processes the temporal expression by using a pre-processed database schema view based on a pre-processing of the aforementioned special database schema, where the pre-processed database schema view is included in pre-processed database schema views 314. The pre-processing of the special database schema can include, for example, using SQL functions or creating new views. Disambiguation engine 304 uses the pre-processed database schema view to extract information from the database, where the extracted information is needed to subsequently generate the native SQL query, as described below.

Data-item generator 306 employs syntactic and semantic parsing and rule matching on the re-written question to generate a corresponding data-item which includes temporal filters.

Native SQL query generator 308 generates a native SQL query based on the rewritten question and the data-item with temporal filters. In one embodiment, native SQL query generator 308 decomposes the rewritten question into SQL clauses and sends the resulting native SQL query to a database 316 for processing to generate a query result for the native SQL query. In one embodiment, NLIDB system 302 sends the query result to the aforementioned device of user that provided question 310, where the query result specifies an answer to question 310.

In one embodiment, a NLP pipeline (not shown) is included in NLIDB system 302 and includes disambiguation engine 304, data-item generator 306, and native SQL query generator 308.

In one embodiment, disambiguation engine 304 is implemented by temporal expression detection module 202, temporal expression type identification module 206, temporal expression resolution module 208, normalization module 210, and question rewriting module 212. In one embodiment, data-item generator 306 is implemented by data-item generation module 214. In one embodiment, native SQL query generator 308 is implemented by native structure query language version generation module 216.

FIG. 4 is a process for processing a temporal question for a NLIDB system, where the process is implemented in the system of FIG. 3 and operations of the process are performed by modules in FIG. 2, in accordance with embodiments of the present invention. The process of FIG. 4 begins at a start node 400. In step 402, question receipt module 202 receives question 310, which is a question in a natural language.

In step 404, temporal expression detection module 204 detects a temporal expression in the question received in step 402.

In step 406, temporal expression type identification module 206 identifies a type of the temporal expression detected in step 404.

In step 408, temporal expression type identification module 206 determines whether the temporal expression detected in step 404 is an irregular temporal expression or a user-defined temporal expression by checking whether the temporal expression matches an entry in dictionary 312, where the entry specifies an irregular or user-defined temporal expression. If an irregular or user-defined temporal expression is determined in step 408, then the Yes branch of step 408 is followed and step 410 is performed.

In step 410, temporal expression resolution module 208 performs extra processing logic by the NLP pipeline in NLIDB system 302 to process the logic of the temporal expression detected in step 204 (e.g., YTY, YTD). Step 410 is included in the aforementioned first approach provided by the enhanced NLIDB system disclosed herein (i.e., NLIDB system 302), so that step 410 includes providing language-based resolution mapping specific business logic to the temporal expression detected in step 204 (e.g., YTY, YTD).

Returning to step 408, if an irregular or user-defined temporal expression is not determined in step 408, then the No branch of step 408 is followed and step 412 is performed.

In step 412, normalization module 210 processes the temporal expression detected in step 404 to convert the temporal expression into a normalized structured date and time. In one embodiment, a date/time annotator included in disambiguation engine 304 performs step 412.

Following step 412 and step 410, step 414 is performed. In step 414, question rewriting module 212 rewrites the question received in step 402 to generate a rewritten question, so that the temporal expression in the question received in step 402 is replaced with normalized values (i.e., normalized date and time) resulting from step 410 or step 412.

In step 416, data-item generation module 214 generates a data-item having temporal filters by using syntactic parsing and semantic parsing and by using rule matching on the rewritten question generated in step 414.

In step 418, temporal expression resolution module 208 determines whether a specified use case associated with a special database schema are indicated by the question received in step 402, thereby either (i) identifying a specified use case and special database schema along with the detected temporal expression being a user-defined temporal expression or a non-obvious or obvious temporal expression, or (ii) not identifying such a special use case and special database schema. If temporal expression resolution module 208 identifies in step 418 the specified use case and the special database schema, then the Yes branch of step 418 is followed and step 420 is performed.

In step 420, if the temporal expression detected in step 404 is a user-defined temporal expression, then temporal expression resolution module 208 extracts from database 316 information needed for native SQL query generation by using a first pre-processed database schema view associated with the specified use case identified in step 418.

In step 420, if the temporal expression detected in step 404 is a non-obvious or obvious temporal expression, then temporal expression resolution module 208 extracts from database 316 information needed for native SQL query generation by using a second pre-processed database schema view associated with the specified use case identified in step 418.

The usage of “first” and “second” in the aforementioned “first pre-processed database schema view” and “second pre-processed database schema view” (and used hereinafter) is a usage of modifiers to simply distinguish between pre-processed database schema views, and does not imply any relative order between pre-processed database schema views.

The first and second pre-processed database schema views are included in pre-processed database schema views 314. The pre-processing of the database schema includes, for example, using SQL functions or creating new views, and is performed prior to step 402. In one embodiment, a database system that includes database 316 (or another computer system which is not shown) performs pre-processing of database schemas to generate pre-processed database schema views 314. The pre-processing of the database schemas is included in the aforementioned second approach provided by the enhanced NLIDB system (i.e., NLIDB system 302) disclosed herein, which provides database-based manipulation to enable the processing of temporal expressions, since the original does not have such capability) (e.g., Billing and Invoicing use case and Source to Pay use case, as described below).

Returning to step 418, if temporal expression resolution module 208 does not identify a specified use case with a special database schema, then the No branch of step 418 is followed and step 422 is performed.

Step 422 follows step 420 and the No branch of step 418. In step 422, native structured query language version generation module 216 generates a native SQL query from the question received in step 402 and based at least part on the data-item generated in step 416. If step 422 follows step 420, then the generation of the native SQL query is also based on the information extracted in step 420. NLIDB system 302 sends the native SQL query generated in step 422 to database 316 for processing to retrieve a query result from database 316, where the query result describes an answer to the question received in step 402.

Following step 422, the process of FIG. 4 ends at an end node 424.

### Example 1

In a first example, the NLP pipeline includes customizations to support temporal questions that include irregular temporal expressions. The first example is an illustration of the aforementioned first approach provided by the enhanced NLIDB system disclosed herein, which provides language-based resolution mapping specific business logic to detected temporal expressions (e.g., YTY, YTD). In this example, NLIDB system 302 processes irregular temporal expressions that include YTY, YTD, and quarter. The processing of the temporal expressions includes executing a series of logic processing steps to resolve the irregular temporal expressions. The calculations and configuration actions described below are examples of the processing included in step 410 in FIG. 4.

The following items describe functionality of NLIDB system 302, which is associated with the NLP pipeline making calculations for the YTY temporal expression:
Retrieve the data for different time periods, which are determined by the type of the query.
Calculate the change over time and present the trend, instead of static data
Make calculations with multiple groupBys (e.g., YTY by region, country, and market)
Determine highest or lowest calculations for entities (e.g., which market has the highest YTY)
Determine comparatives (e.g., which region has higher than 5% YTY growth)

The following items describe configurations provided by NLIDB system 302, which are related to the NLP pipeline making calculations for the YTY temporal expression:
Configure the default year, which is usually the current year
Configure the interval period that data is loaded in the database (e.g., monthly, weekly, etc.)
Configure the cutoff date in the period after which validity of data is not guaranteed (e.g., 15^{th} of the month if the interval period is monthly)

The following items describe time period management actions performed by NLIDB system 302, which are related to the NLP pipeline making calculations for the YTY temporal expression:
YTY calculation is based on interdependent elements: year, quarter, month, week, etc.
Two years are determined by analyzing the query: “destination year” and “prior year.” The years can be explicit or implicit (e.g., YTY for last year, YTY for last quarter). If the destination year is not set, the configured default year is assumed to be the destination year.

The precise time period coverage for both years depends on the destination year:

If the destination year is “current year”:
1. Latest date valid data consideration is set to the configured interval period or cutoff date: End of “last month” if interval period is “month” or 15^{th} of last month if cutoff date is the 15^{th}.
2. Quarter is not set: from beginning of year to the end of “last month”
3. Quarter is “current”: from beginning of current quarter to the end of “last month”
4. Quarter is a past quarter: from beginning of the past quarter to the end of the past quarter)

If destination year is a “prior year”:
1. No cutoff date is set unless the end of the destination period is before the current cutoff date
2. Quarter is not set: from the beginning to the end of the year
3. Quarter is set: from the beginning to the end of the quarter

Two time period examples for the YTY calculation are presented below. In these examples, the ending year period is shown and the same period applies to the previous year. Configuration information for these time period examples includes:
Current year: 2022
Data-entry period: month (
Cutoff date: end of month. Current year is 2022

Time period example 1:

Show YTY revenue growth for this quarter (query date is Jun. 10, 2022):
1. Calculate the revenue from Apr. 1, 2021 to May 30, 2021 (a)
2. Calculate the revenue from Apr. 1, 2022 to May 30, 2022 (b)
3. Calculate the percentage of growth or decline from year 1 to year 2 as (b-a)/a

Time period example 2:

Show YTY revenue growth for Q2 2021 (query date is Jun. 10, 2022):
1. Calculate the revenue from Apr. 1, 2020 to Jun. 30, 2020 (a)
2. Calculate the revenue from Apr. 1, 2021 to Jun. 30, 2021 (b)
3. Calculate the percentage of growth or decline from year 1 to year 2 as (b-a)/a

A list of time period examples is presented below:
Show YTD revenue, which includes the current year up to Today. QTD shows the current quarter up to Today
Show YTY revenue growth for a specific market, which includes the current year up to the end of last month
Show YTY revenue growth in 2017, which includes all of 2017
Show YTY revenue growth in Q2 2017, which includes all of the second quarter in 2017
Show YTD YTY revenue growth, which includes the current year up to the end of last month
Show QtD YTY revenue growth, which includes the current quarter up to the end of last month

### Example 2

In a second example, the NLP pipeline includes customizations to support temporal questions that include user-defined temporal expressions or non-obvious or obvious temporal expressions. The second example is an illustration of the aforementioned second approach provided by the enhanced NLIDB system disclosed herein, which provides a database-based manipulation to enable the processing of temporal expressions, since the original prior to the manipulation does not have such capability (e.g., Billing and Invoicing use case and Source to Pay use case, as discussed below). In this example, NLIDB system 302 processes user-defined temporal expressions related to a Billing & Invoicing use case and further processes non-obvious or obvious temporal expressions related to a Source to Pay use case.

In the Billing & Invoicing use case, for each column in a timestamp (or date) data type in the billing record view, NLIDB system 302 extracts values from the timestamp and creates the columns described below:

The original timestamp value in the database is 2021 Dec. 25 00:00:00

The new columns that are created are:
YEAR 2021
MONTH 12
QUARTER 4
DATE 25
DAY: extract day of week from each column, where values are in the range of 0 to 6 inclusive, where 0 indicates Sunday, 1 indicates Monday, etc.)

The main purpose of adding the columns listed above is to answer queries that require “day of week” information, such as queries that include “during weekends.” The adding of the columns described above is an example of the pre-processing discussed above relative to step 420 in FIG. 4.

For the new column DAY, the original timestamp stored in the database does not have information such as DAY (i.e., Mon/Tue/ . . . ) or weekend (Sat/Sun). The DAY column is used to answer questions with respect to a weekend (i.e., Sat/Sun) or a certain weekday (i.e., Mon/Tue/ . . . )

For the new columns YEAR, MONTH, and QUARTER, NLIDB system 302 supports aggregation functions (e.g., SUM, AVG) and GROUPBY for a period (e.g., per YEAR, MONTH, or QUARTER). Examples that use the new columns include:

Show total revenue per YEAR, MONTH, or QUARTER

Show total revenue per QUARTER of each YEAR

Show total revenue per MONTH of each YEAR

In the Source to Pay use case, NLIDB system 302 converts the duration of period in the user query into a certain value to answer the query. The definition of the columns described below is an example of the pre-processing discussed above relative to step 420 in FIG. 4. The calculations described below relative to the Source to Pay database are based on data that is an example of the information extracted in step 420 in FIG. 4.

In the Source to Pay database, the cost saving information is defined in three columns:

Start Date: start date of the cost savings (e.g., 2022 Jan. 01)

End Date: end date of the cost savings (e.g., 2022 Dec. 31)

Cost Savings Amount from start date to end date (e.g., $12,000)

To answer questions in the form of “What is the total cost savings realized during [period of time]?:

The [period of time] can be any duration, such as 1 H 2022, Q1 2022, until today, etc.

Sample question 1: To answer the question What is the total cost savings realized during 1 H 2022:
1. Count how many months of the cost savings duration are in the database (e.g., 12 months)
2. Count how many months of the cost savings that the user is asking in the question (e.g., 6 months)
3. Calculate: 12000×(6/12), given the assumption that the total cost savings is distributed equally across the 12 months of the cost savings duration in the database.

Sample question 2: What is the total cost savings realized during Q 2 2022

Answering this question uses logic that is similar to how Sample question 1 is answered, as described above.

Sample question 3: What is the total cost savings realized until today (e.g., Nov. 10, 2022)?
1. Count how many months of the cost savings duration are in the database (e.g., 12 months)
2. Count how many months of the cost savings that the user is asking from the beginning of the Start Date of the cost savings until the end of the previous month (e.g., 10 months)
3. Calculate: 12000×(10/12), given the assumption that the total cost savings is distributed equally across 12 months of the cost savings duration in the database.

The descriptions of the various embodiments of the present invention have been presented herein for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
receiving a question in a natural language;
detecting a temporal expression in the question and identifying a type of the detected temporal expression, the type being an irregular, a user-defined, or a special temporal expression, wherein the special temporal expression is a non-obvious or an obvious temporal expression;
resolving the temporal expression and matching an output of a resolution of the temporal expression with temporal data stored in a database by (i) executing, for the irregular temporal expression, a series of processing logic by a natural language processing (NLP) pipeline, (ii) extracting, for the user-defined temporal expression, information from the database by using a first pre-processed database schema view and processing a logic by the NLP pipeline, and (iii) extracting, for the special temporal expression, other information from the database by using a second pre-processed database schema view associated with a specified use case.

2. The method of claim 1, further comprising:
determining that the type is the irregular temporal expression or the user-defined temporal expression,
wherein the identifying the type of the detected temporal expression includes checking a dictionary for an entry in the dictionary that matches one or more attributes of the question and that specifies the type.

3. The method of claim 1, further comprising:
determining that the type is the non-obvious or the obvious temporal expression,
wherein the identifying the type of the detected temporal expression includes identifying the specified use case as being associated with the question.

4. The method of claim 1, further comprising:
determining that the type is the irregular temporal expression or the user-defined temporal expression,
wherein the series of processing logic is defined by an in-domain knowledge of a user.

5. The method of claim 1, further comprising:
generating normalized values for the detected temporal expression;
rewriting the question by replacing the detected temporal expression with the normalized values;
generating a native structured query language version of the rewritten question; and
sending the native structured query language version to a database for processing and a retrieval from the database of a result that includes an answer to the question.

6. The method of claim 5, further comprising:
determining that the type is the user-defined temporal expression,
wherein the generating the native structured query language version is based on the information extracted by using the first pre-processed database schema view and the processing of the logic by the NLP pipeline.

7. The method of claim 5, further comprising:
determining that the type is the non-obvious or the obvious temporal expression,
wherein the generating the native structured query language version is based on the information extracted by using the second pre-processed database schema view associated with the specified use case.

8. The method of claim 5, further comprising:
responsive to the rewriting the question, parsing the rewritten question using an engine for syntactic parsing and semantic parsing;
applying rule matching on the rewritten question; and
based on the parsed rewritten question and the applied rule matching, generating a data-item that includes temporal filters, wherein the generating the native structured query language version of the rewritten question includes converting the data-item into the native structured query language version of the rewritten question.

9. The method of claim 1, wherein the resolving includes a language-based resolution that includes a mapping of specific business logic to the detected temporal expression or a database-based manipulation that enables a processing of the detected temporal expression.

10. A computer system comprising:
a processor set;
one or more computer-readable storage media; and
program instructions stored on the one or more computer-readable storage media to cause the processor set to perform operations comprising:
receiving a question in a natural language;
detecting a temporal expression in the question and identifying a type of the detected temporal expression, the type being an irregular, a user-defined, or a special temporal expression, wherein the special temporal expression is a non-obvious or an obvious temporal expression;
resolving the temporal expression and matching an output of a resolution of the temporal expression with temporal data stored in a database by (i) executing, for the irregular temporal expression, a series of processing logic by a natural language processing (NLP) pipeline, (ii) extracting, for the user-defined temporal expression, information from the database by using a first pre-processed database schema view and processing a logic by the NLP pipeline, and (iii) extracting, for the special temporal expression, other information from the database by using a second pre-processed database schema view associated with a specified use case.

11. The computer system of claim 10, wherein the operations further comprise:
determining that the type is the irregular temporal expression or the user-defined temporal expression,
wherein the identifying the type of the detected temporal expression includes checking a dictionary for an entry in the dictionary that matches one or more attributes of the question and that specifies the type.

12. The computer system of claim 10, wherein the operations further comprise:
determining that the type is the non-obvious or the obvious temporal expression,
wherein the identifying the type of the detected temporal expression includes identifying the specified use case as being associated with the question.

13. The computer system of claim 10, wherein the operations further comprise:
determining that the type is the irregular temporal expression or the user-defined temporal expression,
wherein the series of processing logic is defined by an in-domain knowledge of a user.

14. The computer system of claim 10, wherein the operations further comprise:
generating normalized values for the detected temporal expression;
rewriting the question by replacing the detected temporal expression with the normalized values;
generating a native structured query language version of the rewritten question; and
sending the native structured query language version to a database for processing and a retrieval from the database of a result that includes an answer to the question.

15. The computer system of claim 14, wherein the operations further comprise:
determining that the type is the user-defined temporal expression,
wherein the generating the native structured query language version is based on information extracted by using the first pre-processed database schema view and the processing of the logic by the NLP pipeline.

16. The computer system of claim 14, wherein the operations further comprise:
determining that the type is the non-obvious or the obvious temporal expression,
wherein the generating the native structured query language version is based on the information extracted by using the second pre-processed database schema view associated with the specified use case.

17. A computer program product comprising:
one or more computer-readable storage media; and
program instructions stored on the one or more computer-readable storage media to perform operations comprising:
receiving a question in a natural language;
detecting a temporal expression in the question and identifying a type of the detected temporal expression, the type being an irregular, a user-defined, or a special temporal expression, wherein the special temporal expression is a non-obvious or an obvious temporal expression;
resolving the temporal expression and matching an output of a resolution of the temporal expression with temporal data stored in a database by (i) executing a series of processing logic by a natural language processing (NLP) pipeline, for the type being the irregular temporal expression, (ii) extracting, for the user-defined temporal expression, information from the database by using a first pre-processed database schema view and processing a logic by the NLP pipeline, and (iii) extracting, for the special temporal expression, other information from the database by using a second pre-processed database schema view associated with a specified use case.

18. The computer program product of claim 17, wherein the operations further comprise:
determining that the type is the irregular temporal expression or the user-defined temporal expression,
wherein the identifying the type of the detected temporal expression includes checking a dictionary for an entry in the dictionary that matches one or more attributes of the question and that specifies the type.

19. The computer program product of claim 17, wherein the operations further comprise:
determining that the type is the non-obvious or the obvious temporal expression,
wherein the identifying the type of the detected temporal expression includes identifying the specified use case as being associated with the question.

20. The computer program product of claim 17, wherein the operations further comprise:
determining that the type is the irregular temporal expression or the user-defined temporal expression,
wherein the series of processing logic is defined by an in-domain knowledge of a user.
